(19) United States
(12) Patent Application Publication
(10) Pub. No.: US 2007/0033439 A1
(43) Pub. Date: Feb. 8, 2007

(54) Look-across system

(76) Inventor: Chris Selvage, Indianapolis, IN (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/494,976

(22) Filed: Jul. 28, 2006

Related U.S. Application Data
(60) Provisional application No. 60/703,521, filed on Jul. 28, 2005.

(51) Int. Cl. G06F 11/00

(52) U.S. Cl. 714/26

(57) ABSTRACT

A system and method configured to look across programs, and more specifically, to a look-across program application used to update large and complex amounts of information. The information updated may be FMEA (failure modes and effects analysis) reports. Multiple FMEA reports are updated efficiently according to common attributes between products/processes to other products/processes. The updating is performed logic that cycles through each report once an update is made and looks to other applications to find products/processes with common attributes.

### CROSS-REFERENCE TO RELATED APPLICATIONS

This application claims priority from U.S. Provisional Patent Application No. 60/703,521 filed on Jul. 28, 2005, which is hereby incorporated by reference.

### FIELD OF THE INVENTION

The present invention relates generally to look-across programs, and more specifically, to a look-across program application used to update large and complex amounts of information.

### BACKGROUND

Many industries maintain large and complex amounts of information that need to be periodically updated. Updates or changes in some information may have a dramatic affect on other information being maintained. Manual maintenance of this information is nearly impossible. Likewise, with computerized information, it can also be a daunting task to repeatedly search and find all changes to the information and determine what, if any, affect those changes have on other data. As such, it can be extremely time consuming and burdensome to constantly monitor, input, and update large and complex amounts of information.

One area where such large and complex amounts of information are gathered, maintained, and updated is in Failure Mode and Effects Analysis (“FMEA”) reports. While there are clearly any number of additional areas that maintain and update large and complex amounts of data, FMEA reports are described herein by way of example. FMEA reports are used to identify and prioritize failures in a product or process. FMEA is a method for evaluating the structures of systems and predicting their performance. While FMEA is primarily used in the manufacturing industries, FMEA has also been adapted by numerous other fields to improve processes.

FMEA is a method used for the identification of potential error types in order to define its effect on the examined object and to classify the error types with regard to criticality or persistency. This is to prevent errors and thus weak points in the design that might result in an endangering or loss of the system/software and/or in an endangering of the persons connected with the system/software. FMEA is also used to furnish results for corrective measures, for the definition of test cases and for the determination of operating and application conditions of the system/software.

When a change or update is required to a FMEA report, other processes within the FMEA or across other applications should likewise be reviewed. This procedure is often overlooked due to the time required to make such changes and the complexity related to make such changes. Therefore, there is a need in the art to provide maintenance and update assistance where large and complex amounts of information are maintained, such as with FMEAs.

### BRIEF DESCRIPTION OF THE SEVERAL VIEWS OF THE DRAWING

Objects and advantages together with the operation of the invention may be better understood by reference to the following detailed description taken in connection with the following illustrations, wherein:

FIG. 1 is a screen shot of an embodiment of the present invention depicting the common attributes and filter listing button;

FIG. 2 is a screen shot of an embodiment of the present invention depicting the listing on a separate worksheet of the FMEA look-across file;

FIG. 3 are screen shots of an embodiment of the present invention depicting questions asked by the general macro program to the user;

FIG. 4 are screen shots of an embodiment of the present invention depicting the macro cycling through each part number on the list and opening the related FMEA;

FIG. 5 are screen shots of an embodiment of the present invention depicting the macro opening individual modules and adding the recommended action;

FIG. 6 is a screen shot of an embodiment of the present invention depicting the macro forcing a return back to the FMEA look-across file;

FIG. 7 is a screen shot of an embodiment of the present invention depicting the e-mail group files associated with the programs; and

FIG. 8 is a screen shot of an embodiment of the present invention depicting the macro opening a new e-mail containing all relevant information.

### DETAILED DESCRIPTION OF THE INVENTION

The invention will now be described in accordance with the preferred embodiment as used to maintain and update FMEA reports. However, it will be appreciated that modifications and alternative designs could be utilized upon reading and understanding the detailed description and still be within the scope of the invention as contemplated. As such, the following description is presented by way of illustration only and should not limit in any way the various alternatives and modifications that may be made to the illustrated embodiment and still be within the spirit and scope of the invention. Also, it will be appreciated that this invention is not limited to use with FMEA reports, but that it may be utilized to maintain and update any large or complex amount of information. The invention can be adapted to use a variety of database, spreadsheet, e-mail, and macro software to enhance information look-across and update information therein with notifications.

FMEA is a systematic way to evaluate a process in order to identify where and how it might fail and to assess the relative impact of different failures. This is useful in identifying the parts of the product or process that are most in need of change. Stated another way, FMEA is a systematic approach to prioritizing changes required for certain products or processes. However, once a change is made to one product and/or process in the FMEA report, each of the similar product and/or processes in the FMEA should be reviewed to determine if the previous change impacts the similar products and/or processes. The task, however, of reviewing other similar products or processes in FMEA reports can be tedious and is often overlooked.

The present embodiment utilizes a look-across program to generate a list of related products and processes to a product or process so changed. The present look-across program utilizes Microsoft Excel and Excel macro add-in to simplify the task of generating a list of related products or processes. Next, the look-across program utilizes a general macro program to automatically update the relevant FMEAs and notifies a predetermined/particular team related to each FMEA that an update has been made and additional actions are required. However, it should be understood that the present invention is not limited to using Microsoft Excel and/or Excel macro add-ins. Other programs, applications, software, or processes could be utilized other than those described above to perform the same functions. For example, any sort of appropriate spreadsheet software program can be used. Additionally, any customized software program can be used without departing from the present invention. Currently, FMEAs are documented in a system called Plexus, but other systems could also be used.

The look-across system enhances the process with a look-across database and an automatic FMEA update and email notification of updates and additional actions required. Please reference the attached flow diagrams with screen shots of the process. This process uses the benefits of Excel's macro add-in and an additional Microsoft Windows based macro program to automate the updating of FMEAs and email notifications to appropriate individuals. The macros can also be logic configured to perform the aforementioned functions. Again, it should be understood that any sort of software program can be used, not just Excel's macro programs. In particular, the present look-across system can utilize a customized software package to accomplish the same or similar tasks.

A macro is a way to automate a task that one performs repeatedly or on a regular basis. It is a series of commands and actions that can be stored and run whenever needed to perform a certain task or tasks. One can record or build a macro, and then utilize the macro to automatically repeat the series of commands or actions. The look-across system utilizes the macro program such that the macro program will use the generated part list and update all impacted FMEAs.

In this situation only recommended actions will be completed with a new RPN value of 1000. The RPN (Risk Priority Number) is the calculation of the risk of failure in a process or product. A low RPN (<80) is desirable and often required by the customer. The RPN is calculated by the combination of Severity of failure (Sev.), the probability of Occurrence (Occ.), and ability to detect the failure (Det.). By multiplying these three factors, the Risk Priority Number (RPN) is created (RPN=Sev.×Occ.×Det.). In an FMEA, the goal is to identify, reduce and minimize the potential for failure. The recommended action section of the FMEA shows the new calculation of the reduction in the RPN. The macro program “Increases” all factors to 10 to create a new RPN of 1000, (worst possible risk factor). This requires the cross-functional team to revisit the modified FMEA and determine the true reduction in the FMEA after actions have been documented.

A detailed action plan is also included with the recommended action developed by a cross-functional team. The cross-functional team will be required to update the RPN to reflect the action plan taken. The macro program will step through each part number in the list and update the FMEAs with automated notification of the changes to the FMEA. Each part will have an associated program. The cross-functional team for each FMEA will be notified automatically. A list of program names associated with each cross-functional team e-mail list will be maintained. The macro program will automatically e-mail the team members of the affected product or process.

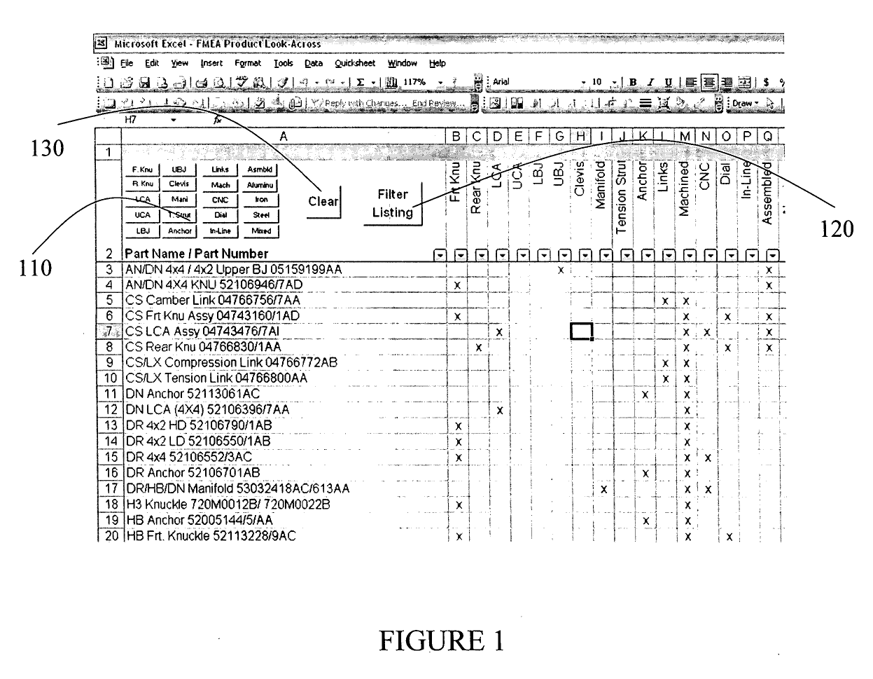

Referring to the drawings, there is shown a look-across system utilizing an embodiment of the present invention. In particular, as shown FIG. 1, the look-across system determines what common attributes the process/product has to other processes/products. Then, the common attributes button 110 shows that a determination is made as to what common attributes the process/product has to other processes/products (e.g.; same type of product, same type of machine, same type of process, etc.) when the user presses the appropriate buttons 110. As shown in FIG. 1, processes/products with a common attribute with another processes/products are shown on the screen by an “X,” although there are other ways to show the common attribute other than an “X” such as a check mark, highlighting the box, etc. Next, a list of FMEA updates can automatically be generated. To do so, a user presses the filter listing button 120 and a list for automatic FMEA updates is generated. Alternatively, a user can clear the listing by pressing the clear button 130. This would occur if the user accidentally pressed the wrong button.

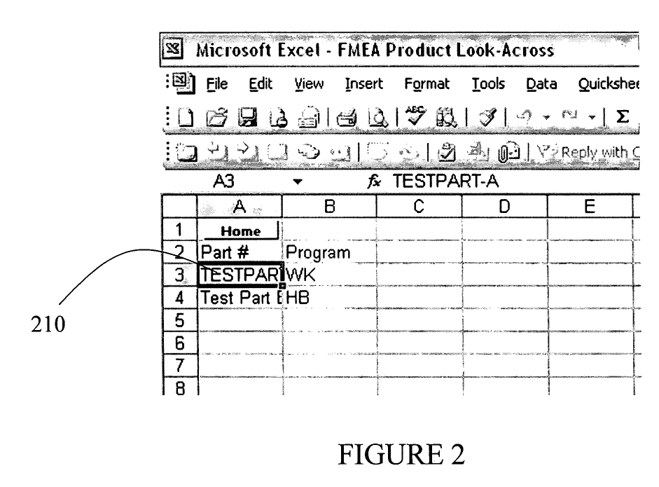

In the next step, the look-across system creates a listing of process numbers, product numbers, part numbers, and programs associated with such common attributes. As shown in FIG. 2, look-across system creates this listing 210 on a separate worksheet in the FMEA look-across file after the filter listing command is executed.

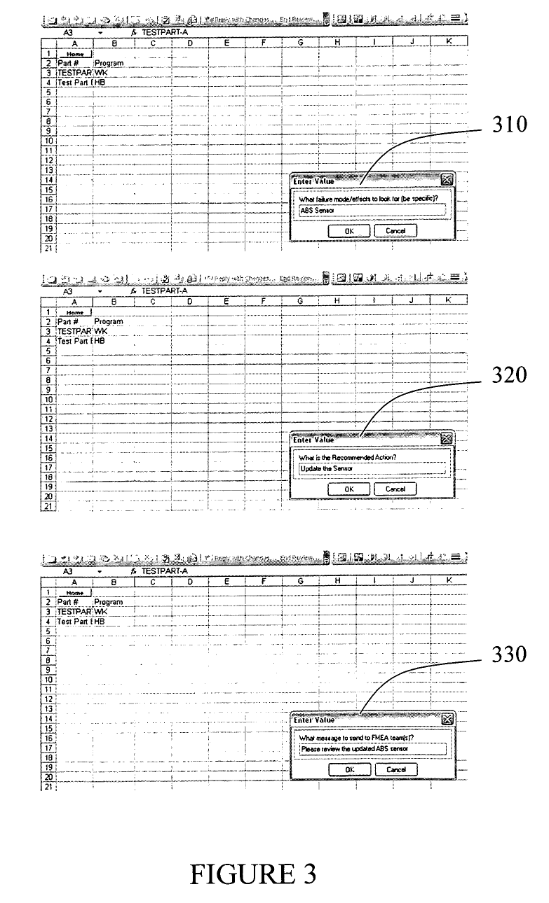

In the next step, the general macro program is utilized. In the present embodiment, the general macro asks the user three questions: 1) What failure mode/effects to look for? 2) What is the recommended action? and 3) What message to send to FMEA team(s)? These questions, however, are merely exemplary questions and the present invention is not limited to these three questions. Any number of questions and any questions that provide sufficient information can be utilized. As shown in FIG. 3, the above-referenced three questions are prompted to the user. A processor controls the prompting of the user questions. The first question 310 is what failure mode/effects to look for. Next, the user enters a response to the question. The following question 320 asks what the recommended action is supposed to be. After the user enters a response to the second question 320, the next question 330 is what message is to be sent to the FMEA teams. The macro program will begin searching after the user answers the last question 330.

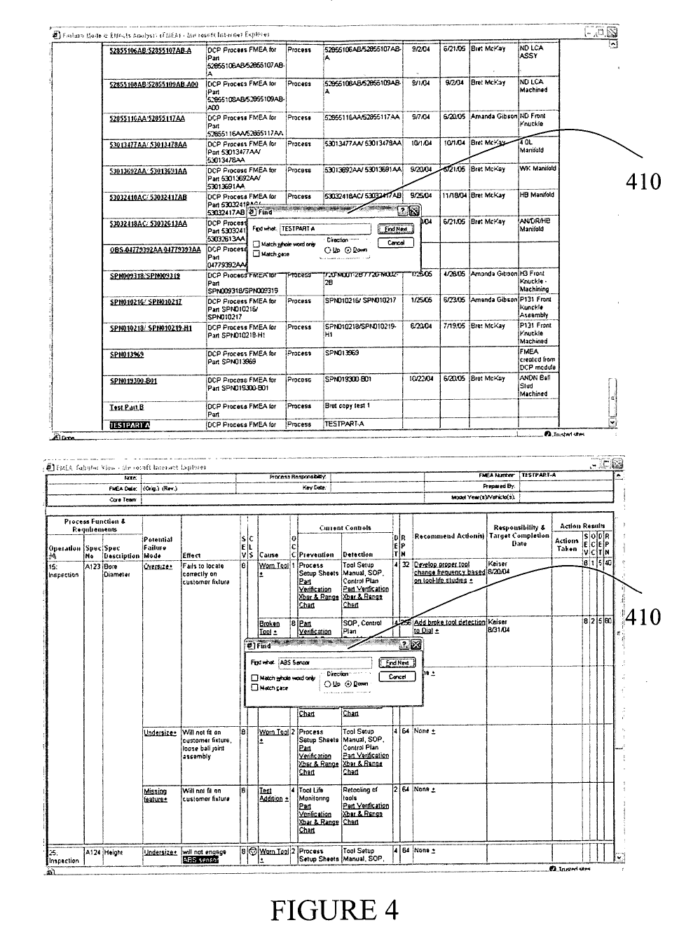

In the next step, the macro will continue to operate without human intervention, it will continue automatically. The macro will cycle through each product, process, or part number on the list and open the related FMEA to update the recommended action. As shown in FIG. 4, the macro automatically does this using a find feature 410. The find feature can search whole words and/or case. The macro will cycle through each product, process, or part number on the list and open the related FMEA for updating the recommended action.

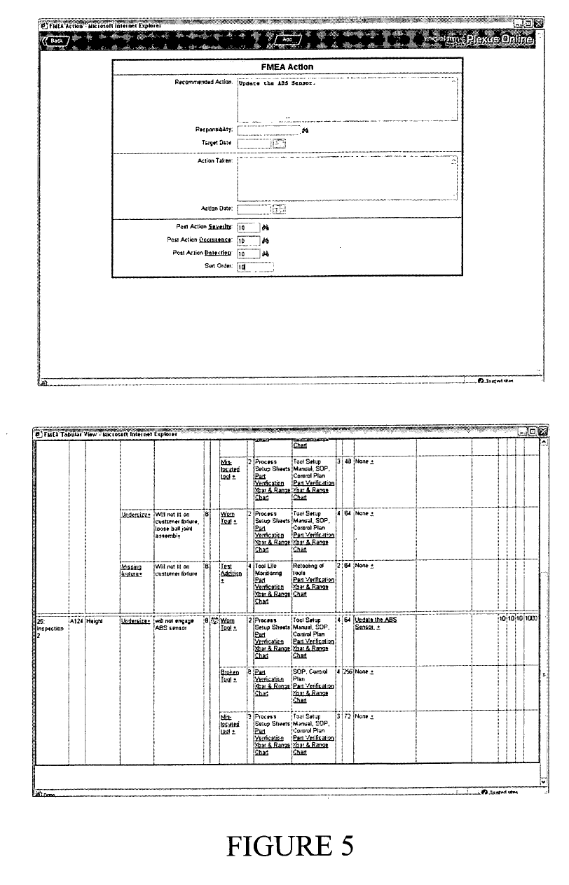

Once the find feature has completed its search, the macro will open the individual module and add the recommended action to each module. This is shown in FIG. 5. The find feature 510 opens the related FMEA for updating the recommended action. Subsequently, the macro will open the individual module and add the recommended action. The action taken, however, is not updated and the severity, occurrence, and detection numbers are each changed to 10 (highest possible, lowest is better) so that the resultant RPN is 1000 as indicated earlier. This will force the FMEA team to make additional updates to the FMEA. FIG. 5 further shows a scrolled down view of the screen with the recommended action already added to the individual module.

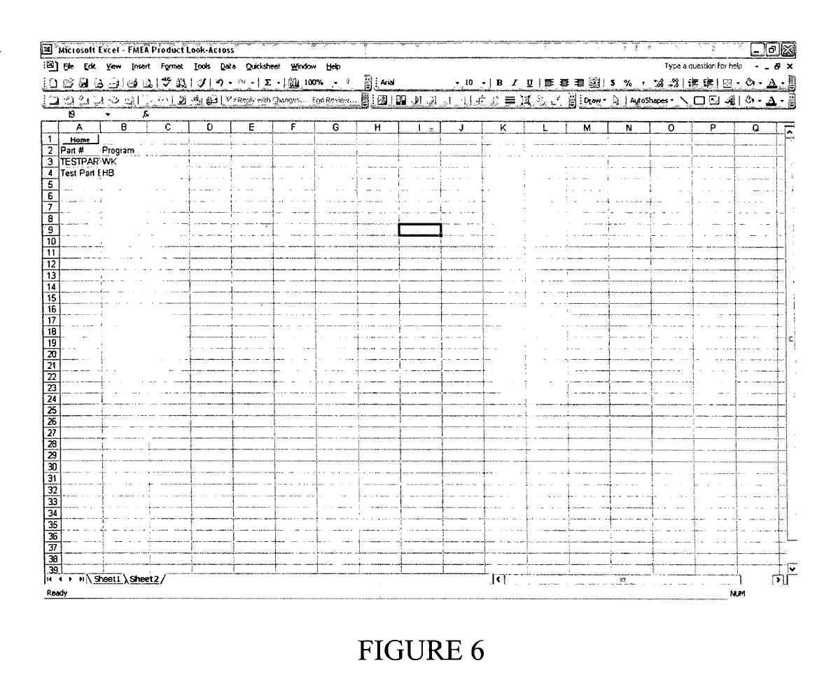

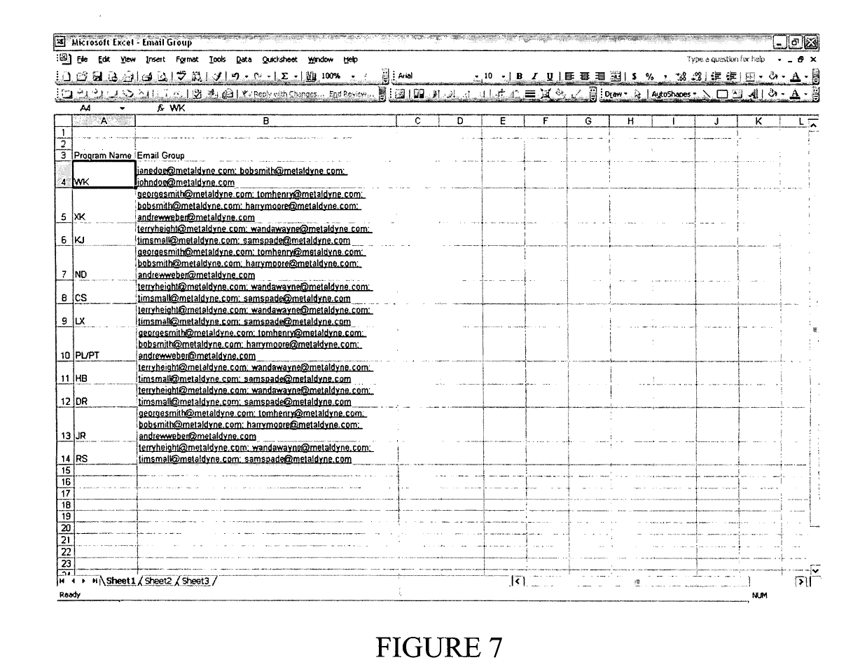

The macro then forces a return back to the FMEA look-across file to find and view the associated program to the particular product, process, or part number. In this event, the user automatically returns to the original FMEA look across-file. FIG. 6 shows the screenshot with the original FMEA look across file as it would be viewed by the user. The look-across file maintains a separate e-mail group file that associates program names to lists of e-mails for the members of the team handling that particular program. FIG. 7 is a screen shot showing that the separately maintained email group file that associates program names to the list of e-mails of the members of such program teams. The e-mails are then sent to people in the FMEA teams that are responsible for making the additional updates to the FMEA based on the recommended action.

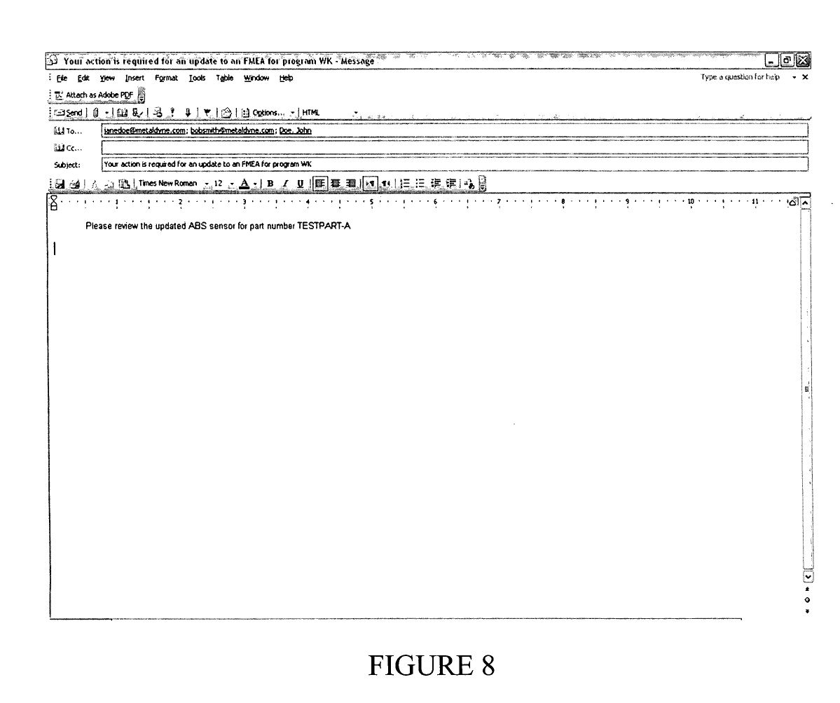

Finally, the e-mail group is copied and the macro then opens a new e-mail and all relevant information is automatically copied (no keystrokes required). As shown in FIG. 8, there is also text written in the e-mail message. The text can be generated by the software or by the user. Moreover, the user can edit the text of the computer. After completion of all these steps, steps 4-7 are repeated until the listing from step 3 is completed.

It will be appreciated that, although specific embodiments of the invention have been described herein for purposes of illustration, various modifications may be made without departing from the spirit and scope of the invention.

Having thus described the invention, I claim:

1. A method of updating large and complex amounts of information, said method comprising:
identifying at least one item in a list having at least one common attribute with a predetermined item;
listing said item having common attributes with said predetermined item;
requesting further information from a user to determine a recommended action;
updating said listing of said item with said recommended action; and
notifying a predetermined team of said updated listing.

2. The method of claim 1, wherein said predetermined item includes a predetermined product or process.

3. The method of claim 2, wherein said at least one item includes at least one product or process.

4. The method of claim 3, wherein said at least one product or process is substantially similar to said predetermined product or process.

5. The method of claim 1, wherein identifying at least one item having at least one common attribute with a predetermined item comprises identifying a plurality of items having at least one common attribute with a predetermined item.

6. The method of claim 5, wherein said list is a plurality of failure mode and effects analysis reports.

7. The method of claim 6, wherein said requesting further information from said user comprises asking at least one question to said user to determine at least one recommended action.

8. The method of claim 7, wherein asking at least one question to said user comprises asking three questions to said user.

9. The method of claim 8, wherein said three question comprise:
What failure mode/effects to look for?
What is said recommended action?
What message to send to said predetermined team?

10. The method of claim 1, wherein identifying at least one item in said list having at least one common attribute with said predetermined item is accomplished by a software program.

11. The method of claim 1, wherein said listing said item having common attributes with said predetermined item is accomplished by a software program.

12. The method of claim 1, wherein said requesting further information from said user to determine a recommended action is accomplished by a software program.

13. The method of claim 12, wherein said requesting further information from said user is accomplished by a macro program.

14. The method of claim 1, wherein said updating said listing of said item with said recommended action is accomplished by a software program.

15. The method of claim 14, wherein said updating said listing is accomplished by a macro program.

16. The method of claim 1, wherein said notifying a predetermined team of said updated listing.

17. The method of claim 16, wherein said notifying said predetermined team is accomplished by a macro program.

18. A method of updating large and complex amounts of information, said method comprising:
determining common attributes a process or product has to other processes or products contained in a list;
generating a second list of said other processes or products;
asking a set of predetermined questions to a user to determine recommended actions;
generating a third list of said other processes or products based on answers to said questions;
opening individual modules of said other processes or products on said third list;
updating said individual modules with said recommended action; and
notifying a predetermined team of said updated individual modules.

19. The method of claim 18, further comprising viewing each said individual module.

20. The method of claim 19, wherein said first list is a plurality of failure mode and effects analysis reports stored in a database.

21. The method of claim 20, wherein said updating said individual modules with said recommended action comprises updating said failure mode and effects analysis reports with recommended actions.

22. A look across system comprising:
storage storing a plurality of reports;
a plurality of commands to determine what common attributes said reports have with a predetermined report;
a filter that generates a list for automatic updates to said reports;
a processor that requests additional information from a user;
logic that automatically cycles through each report and opens reports having common attributes to said predetermined report for updating recommended action;
wherein said logic will add said recommended action to said reports.

23. The system of claim 22, wherein said processor requests additional information from said user by asking said user: what to look for, what is at least one recommended action, and what message to send.

24. The system of claim 23, wherein said reports comprise failure mode and effects analysis reports.

25. The system of claim 24, wherein said predetermined report comprises a predetermined failure mode and effects analysis report.

26. The system of claim 25, wherein said message to send is sent to failure mode and effects analysis teams.

27. The system of claim 26 wherein said message is sent by e-mail.

28. The system of claim 27, wherein said logic is a macro.

29. The system of claim 28, wherein said macro is an Excel macro or other Microsoft Windows based macro.

30. The system of claim 29, wherein said updating is performed automatically.

31. The system of claim 30, wherein said storage is a Plexus system.
